(19) United States
(12) Patent Application Publication
(10) Pub. No.: US 2009/0110285 A1
(43) Pub. Date: Apr. 30, 2009

(54) APPARATUS AND METHOD FOR IMPROVING IMAGE RESOLUTION USING FUZZY MOTION ESTIMATION

(75) Inventors: Michael ELAD, Kiriat Tivon (IL); Matan Protter, Haifa (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: Technion Research and Development Foundation Ltd, Haifa (IL)

(21) Appl. No.: 12/178,663

(22) Filed: Jul. 24, 2008

Related U.S. Application Data
(60) Provisional application No. 60/982,800, filed on Oct. 26, 2007.
(60) Provisional application No. 61/015,420, filed on Dec. 20, 2007.

(51) Int. Cl. G06K 9/46; G06K 9/40

(52) U.S. Cl. 382/190; 382/254

(57) ABSTRACT

The subject matter discloses a method and apparatus for re-sampling a sequence of images in order to improve its resolution, fill-in missing pixels, or de-interlace it. The method operates locally in the images to be processed, comparing pixel values of pixels surrounding the target pixel to pixel values of substantially the same locations in neighboring images. The comparison results in assigning a weight value for each area compared with the area containing the reviewed pixel. The pixel value of the reviewed pixel is updated as a function of multiplying pixel values of the areas by the weight assigned to each area. In another embodiment, areas within the same image are compared to areas containing the reviewed pixel. The subject matter also discloses two possible penalty functions for improving the resolution of images.

### RELATED APPLICATIONS

This application claims priority from provisional application No. 60/982,800 filed Oct. 26, 2007, provisional application No. 61/015,420 filed Dec. 20, 2007, and from which is hereby incorporated by reference.

### BACKGROUND OF THE INVENTION

1. Field of the Invention

The present invention relates to image processing in general and to re-sampling and improving resolution of images in particular.

2. Discussion of the Related Art

Super-resolution image reconstruction is a form of digital image processing that increases the amount of resolvable details in images and thus its quality. Super-resolution generates a still image of a scene from a collection of similar lower-resolution images of the same scene. For example, several frames of low-resolution video may be combined using super-resolution techniques to produce a single or multiple still images whose true (optical) resolution is significantly higher than that of any single frame of the original video. Because each low-resolution frame is slightly different and contributes some unique information that is absent from the other frames, the reconstructed still image contains more information, i.e., higher resolution, than that of any one of the original low-resolution images. Super-resolution techniques have many applications in diverse areas such as medical imaging, remote sensing, surveillance, still photography, and motion pictures.

Other related problems in image processing that benefit from the advancement in super-resolution are de-interlacing of video, inpainting (filling in missing information in an image/video), and other problems, where one desires a new form of visual data, re-sampled from the given images. Many of the techniques available for super-resolution are applicable to these problems as well.

In the mathematical formulation of the problem, the available low-resolution images are represented as resulting from a transformation of the unknown high-resolution image by effects of image warping due to motion, optical blurring, sampling, and noise. When improving the resolution of an image that is part of a sequence of images, such as images taken from a video camera, highly accurate (sub-pixel accuracy) motion estimation is required for improving the resolution. Known solutions for determining motion vectors do not provide sufficient results in case of non-continuous movement of objects, for example, a tree moving due to wind, or moving persons in a scene.

Known methods for improving the resolution of images either process data acquired within the image, and thus failing to recover details smaller than the sensor size, or process data also from other images, but require accurate motion estimation to do so. On general sequences, motion estimation is usually prone to inaccuracies as well as errors. These inaccuracies cause the outcome of the processing to be of relatively low quality. Therefore, it is desirable to provide a method and apparatus for improving the resolution of images without using motion vectors, or put more conservatively, provide a method that uses motion estimation implicitly, rather than explicitly.

All the discussion brought here is applicable to other re-sampling problems as mentioned above, such as inpainting and de-interlacing, while the description is focused on super-resolution in the following description for clarity.

### SUMMARY OF THE PRESENT INVENTION

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 illustrates a computerized environment 100 implementing methods for improving the resolution of an image, according to an exemplary embodiment of the subject matter;

FIG. 2 discloses a sequence of images, a handled pixel and neighboring pixels according to an exemplary embodiment of the invention;

FIG. 3 illustrates a handled image and two neighboring images, and a method for determining a pixel value in an up scaled low-resolution image, according to an exemplary embodiment of the subject matter; and,

FIG. 4 illustrates a low-resolution image Y (410) on which a method for generalizing non-local means (NLM) algorithm for improving the resolution is implemented, according to an exemplary embodiment of the subject matter.

### DETAILED DESCRIPTION OF THE PREFERRED EMBODIMENT

The disclosed subject matter describes a novel and unobvious method for improving the resolution of an image and avoiding the requirement of motion estimation when handling a sequence of images.

One technical problem addressed by the subject matter is to improve the resolution of images in a sequence of images, and allow simultaneous processing of date both within the image and between images. Super-resolution (SR) refers in some cases to a group of methods of enhancing the resolution of an imaging system. Further, when a sequence of images contains motion of one or snore objects, motion estimation is required for correcting the low-resolution images. Furthermore, objects' motion is necessary in providing classic SR. However, when the motion is not of simple form known motion-estimation solutions cannot provide sufficient results, for example in many cases such solutions wrongfully identify multiple objects instead of one. Hence, a method for improving the resolution of images within a sequence of images while avoiding determination and storage of motion vectors and motion estimation is another technical problem addressed in the subject matter.

The technical solution to the above-discussed problem is a method for improving the resolution of a low-resolution image by utilizing data acquired from multiple neighboring images as well as from the handled image. The method does not attempt to determine one specific location for each pixel in a high-resolution image in the neighboring images. In an exemplary embodiment of the subject matter, the method utilizes temporal neighboring images of the handled image, for example 10 images captured before the handled image, 10 images captured after the handled image, and the handled image itself. For each pixel in the handled image, pixel values of the pixels surrounding the handled pixel are compared to pixel values of pixels located in the same locations or nearby locations in neighboring images.

After comparing the pixel values of the pixels surrounding the handled pixel with pixel values of pixels located in the same locations of neighboring images, a weight value is determined as a function of the pixel values. In other embodiments of the disclosed subject matter, comparison between images is performed using other image-related parameters besides pixel values, for example gradients, gradients size, gradients direction, frequency domain values, transform domain coefficients and other features that that may be valuable for a person skilled in the art. Next, the pixel values of pixels located in the vicinity of the location of the handled pixel in the neighboring images are combined by the weighted average value. In an exemplary embodiment of the subject matter, the above-identified combinations are summed and divided by the sum of all weight values for normalizing the value of the sum. The pixel value determined for the handled pixel is a function of pixel values of pixels in neighboring images the weight values. In some embodiments, the pixel value is divided by a factor for normalizing.

The method described above is one embodiment of an algorithm for providing super resolution without motion compensation. Two implementations of parts of the algorithm detailed below provide better results than determining motion vectors, sometimes with less complexity. One algorithm discloses fuzzy motion techniques for super resolution and the other algorithm discloses the use of non-local means (NLM) algorithm for determining an optimal penalty function that enables determining the optimal high-resolution image.

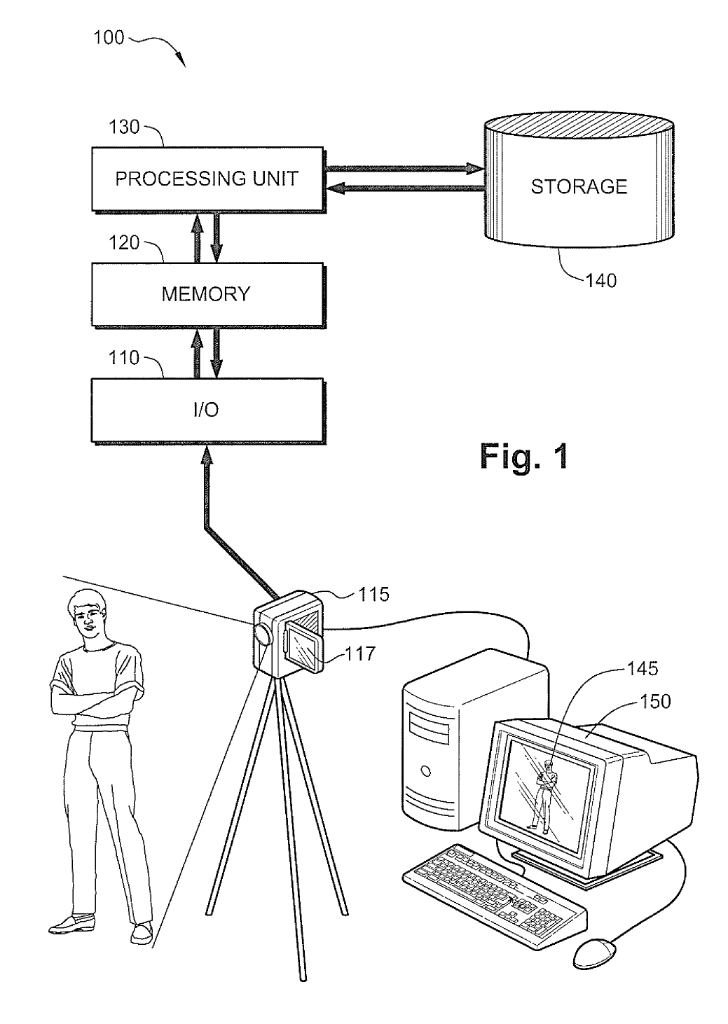

FIG. 1 illustrates a computerized environment 100 implementing methods for improving the resolution of an image, according to an exemplary embodiment of the subject matter. The low-resolution image can be acquired from sources such as a camera, a video camera, a scanner, a range camera, a database and the like. Computerized environment 100 comprises an input-output (I/O) device 110 such as, ports, Memory-mapped I/O and the like, for receiving an image using an imaging device 115 capturing a handled image 117. Handled image 117 is transmitted to a memory unit 120, where a processing unit 130 processes handled image 117. Processing unit 130 performs steps concerning the resolution of the handled image 117 as described below. Processing unit 130 receives data related to the neighboring images of the handled image 117 from memory unit 120. Such data is preferably pixel values, pixel locations in case the data is provided in the spatial domain or data related to frequency domain values of the handled image 117 and additional images, preferably temporal-neighboring images. The temporal-neighboring images are preferably loaded to memory unit 120 in order to reduce time required when the images are retrieved from storage device 140, such as a disk or any other storage device.

The steps detailed above are preferably implemented as interrelated sets of computer instructions written in any programming language such as C, C#, C++, Java, VB, VB.Net, or the like, and developed under any development environment, such as Visual Studio.Net, J2EE or the like. It will be appreciated that the applications can alternatively be implemented as firmware ported for a specific processor such as digital signal processor (DSP) or microcontrollers, or can be implemented as hardware or configurable hardware such as field programmable gate array (FPGA), application specific integrated circuit (ASIC), or a graphic processing unit (GPU). The methods can also be adapted to be executed on a computing platform, or any other type of computing platform that is provisioned with memory unit 120, processing unit 130, and I/O devices 110 as noted above.

In accordance with some embodiments of the subject matter, processing unit 130 handles the image 117 pixel by pixel. Next, processing unit 130 compares the area surrounding each handled pixel with the area surrounding the pixel in the same location or in nearby locations in the neighboring images. The neighboring images are preprocessed and up-scaled to be in a desired size, preferably the size of the desired super-resolution images, or a size that is a function of the size of the largest image in the sequence of low-resolution images. For example, when the handled images are 100×120 pixels, and the desired size is 300×240, the images are up-scaled, for example by an intra-polation or interpolation process, in either a linear or non-linear manner. In various embodiments of the subject matter, the rescaling factor is equal in both axes, so the desired image is 300×360. After the step of upscaling, the neighboring images and the handled image 117 are stored in storage device 140 or in memory unit 120. Pixel values of pixels that are part of the low-resolution images and the locations of those pixels in the high-resolution images are also stored in storage device 140.

Processing unit 130 compares pixel values of the pixels surrounding the handled pixel in the handled image 117 with pixels values of pixels in temporal-neighboring images, preferably after at least some of the images are interpolated to a desired scale Processing unit 130 assigns a weight value for at least a portion of the pixels in a three-dimensional or two-dimensional neighborhood of the handled pixel in neighboring image, as a function of the difference between pixel values (or other measures) of each area within each temporal-neighboring image to the area surrounding the handled pixel in the handled image 117. Such weight value may be a Mean Squared Error (MSE) or any other function or measurable attribute that enables comparison between pixel values for determining differences between areas of images. The weight value is determined for each neighboring image as a function of the value described above. Such weight value may be the exponent of the value −MSE*T, when T is a predetermined value. An alternative weight value may be 1/MSE. The weight function and various image-related parameters required in the computation process may be adaptively selected for each handled pixel.

In some exemplary embodiments of the disclosed subject matter, processing unit 130 receives pixel values from memory unit 120 and determines the weight values according to a method stored in storage device 140. Such method, and the values of parameters related to the method, may be selected by processing unit 130 from a variety of methods according to data related to the pixel values, location of pixels, image size, and the like.

The weight value may indicate an inverse correlation between the result of the previous comparisons and the importance of an area compared to an area containing the handled pixel. For example, when the difference between pixel values of two compared areas of pixel is big, the importance of the pixel values of one area on determining the pixel values of the other area is relatively low. Another parameter that may affect the weight value is the time elapsed or the number of captured images between capturing the handled image and the specific neighboring image assigned with the specific weight value.

Next, the value of the handled pixel is determined as a function of the weight values and the pixel values related to pixels within the original images. After determining the pixel value of the handled pixel, the pixel is updated with the new pixel value. Alternatively, another image is generated, and the new pixel values are inserted in the other image. In some exemplary embodiments of the subject matter, the weight values are multiplied by a function of all pixel values in the detected area of each neighboring image. Alternatively, only pixel values of pixels within the low-resolution image are multiplied by the weight value when determining the value of the handled pixel. In some embodiments of the method, the value of the handled pixel is determined as the sum of all multiplications of the neighboring images divided by the sum of weight values for normalizing the value. In other alternative embodiments, the value of the handled pixel is determined as a function of the pixel values and the weights. In other embodiments, the weights are re-calculated, using the pixel values determined after one iteration of the method and the new weights of the image after one iteration of the super resolution method of the disclosed subject matter.

In accordance with some alternative embodiments of the subject matter, determination of at least a portion of the pixel values of the handled image may be performed according to pixel values of the previous handled image in the sequence of images. For example, in case the level of similarity of one area in the handled image respective to an area in the previous image is higher than a predetermined threshold value, the pixel values of the at least a portion of the pixels in the handled image are determined as a function of the pixel values of the previous image. This alternative method may be added to the method described above, for reducing complexity of the calculations, in accordance of predetermined conditions and terms related to image-related parameters.

After the pixel values in the up-scaled image are determined, a step of deblurring is performed using known methods such as total variation deblurring. Data required for deblurring, such as a set of rules for determining the proper method for improving the resolution of the handled image may be stored in storage device 140. In an exemplary embodiment of the subject matter, the updated super resolution image 145 may be displayed on monitor 150. The steps described above, mainly of up-scaling the image and comparing pixels values of the detected image with neighboring images, obtaining weight values for each neighbor image and determining the pixel values of pixels in the high resolution image are preferably performed by a computerized application.

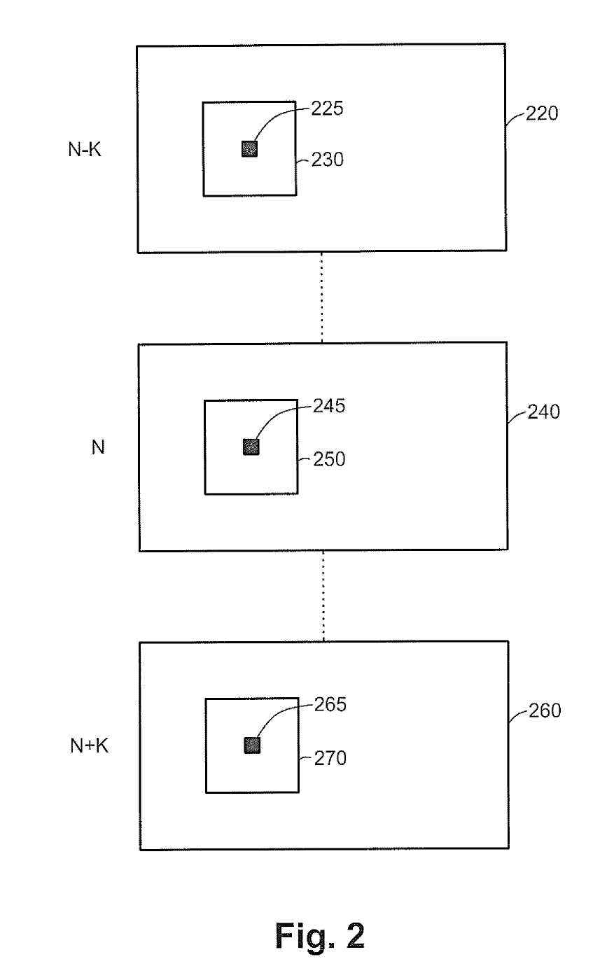

FIG. 2 discloses a sequence of images, a handled image, and temporally neighboring images, and a handled pixel in these images according to an exemplary embodiment of the invention. FIG. 2 exemplifies the images on which the super-resolution methods are performed, according to some exemplary embodiments of the subject matter. The result of the methods is determining the pixel value of pixels in image N (240), which is the handled image. In an exemplary embodiment of the subject matter, the first step is preferably up-scaling the images in the sequence of images. For example, images 220, 240, 260 are up-scaled to be sized 240×300 pixels. In other words, the up-scaled images contain 240 rows and 300 columns, a total of 72,000 pixels. When processing unit 130 determines the pixel value of handled pixel 245 within handled image N (240), pixel values of pixels in area 250 surrounding handled pixel 245 are compared to the neighboring images. Area 250, as well as other areas of image 240 contains a group of pixels each having a pixel values, located in the vicinity of handled pixel 245. The size of area 250 may be predetermined or determined by processing unit 130 according to data associated with detected images or pixel values. Area 250 is preferably defined in terms of pixels located in rows and columns in the vicinity of the row and column of handled pixel 245. According to an exemplary embodiment of the disclosed subject matter, the pixel values of pixels within area 250 are compared to pixel values of areas located within a number of 2*M neighboring images, wherein M of the neighboring images were captured before handled image N (240) and M images were captured after handled image N (240). In another preferred embodiment, the number of images captured before the current picture that are considered in the process can be different from the number of images captured after the current image are considered. Further, previously processed image or images may be used in addition or instead of the original up-scaled images. Additionally, pixel values of area 250 are compared to areas located in different locations in neighboring images. The difference between the location of area 250 containing handled pixel 245 in handled image N (240) and the location of areas compared to area 250 in the neighboring images is named the range of each area compared to area 250. According to other exemplary embodiments of the disclosed subject matter, area 250 is compared only to a portion of the areas in the predetermined range. For example, area 250 is compared only to areas centered in an odd row number.

In the example described below, the handled pixel 245 is located in row 32 and column 55 of handled image 240. The side of area 250 is determined to be 10 pixels. As a result, pixels belonging to rows 22-42 and columns 45-65 are part of area 250, which thus contains 21 rows and 21 columns. In some exemplary embodiments of the subject matter, the number of rows of an area may differ from the number of columns. The pixel values of pixels within area 250 are compared to pixel values of pixels within areas within neighboring images, such as area 230 of image N−M (220) and area 270 of image N+M (260). The location of area 230 in image N−M (220) is substantially the same location of area 250 in handled image N (240).

Additionally, area 250 is compared to areas in the neighboring images located near the location of area 250 in handled image N (240). In other embodiments, the pixel values of pixels in area 250 maybe compared to areas in the handled image N (240). For example, in case area 250 is located in rows 22-42 and columns 45-65, additional comparisons are performed between area 250 and areas having offset of one column to the left, i.e. comprises rows 22-42 and columns 44-64 within neighboring images. Another example of an area offset in four columns to the left and two rows up, relative to the location of area 250, i.e. comprises rows 24-44 and columns 41-61. In exemplary embodiment, wherein the number of areas used in each neighboring image is 25, using an offset of two rows in each direction and two columns in each direction, the number of areas in each neighboring image is 25. These 25 areas are extracted from at least a portion of the neighboring images and the handled image.

When comparing pixel values of area 250 with areas of neighboring images within the predetermined range, a weight value is obtained for each comparison. When determining the pixel value of handled pixel 245 within handled image N (240), one exemplary method is to determine the average of pixel values in each area and multiply the average with each weight value, and sum all multiplications. Another embodiment discloses steps of summing the pixel values of the centers of the areas, by multiplying the pixel values by the weights and divide by the sum of weights. According to some exemplary embodiments of the subject matter, the next step is to divide the result of the multiplications by the sum of all weight values for normalizing the determined pixel value. In another exemplary embodiment of the method of determining the pixel value of handled pixel 245, the average associated with each area compared with area 250 refers only to pixel values of pixels that were part of the original low-resolution images, before the step of up-scaling. Such average is multiplied by the relevant weight value and divided by the sum of weight values to provide the pixel value of handled pixel 245.

The number of neighboring images compared to the handled image, the range and thus the number of areas compared to the area of the handled pixel in each neighboring image, and the size of the area 250 may be predetermined and uniform for each handled pixel or handled image, or may be determined per pixel according to several parameters. Such parameters may be the difference between pixel values of the handled image, previous MSE values, standard deviation or average of previous comparisons, and the like.

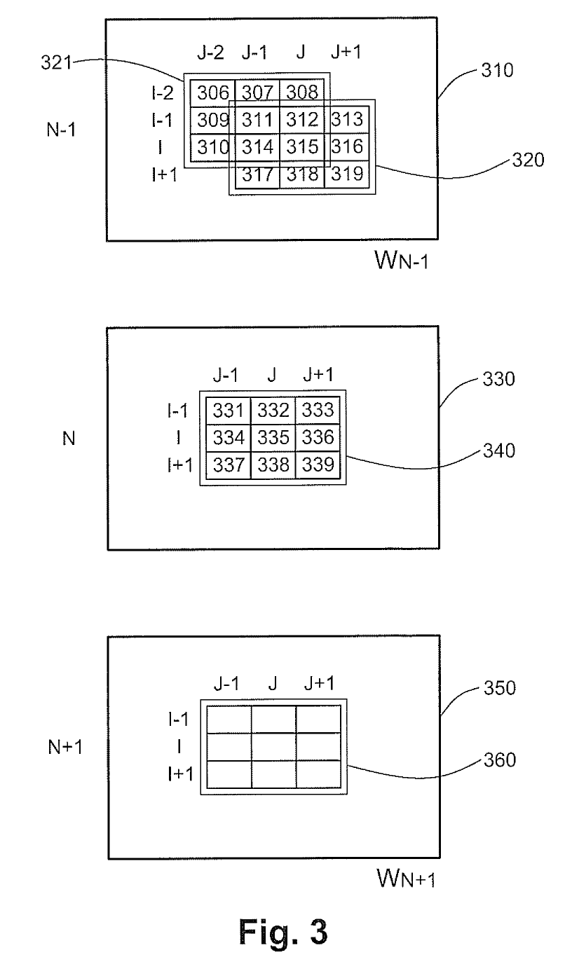

FIG. 3 illustrates a handled image and two neighboring images, and a method for determining a pixel value in an up-scaled low-resolution image, according to an exemplary embodiment of the subject matter. The methods disclosed in the descriptor of FIG. 3 provide another embodiment for implementing super-resolution methods. Handled image N (330) is an image that was initially captured by a capturing device (such as 115 of FIG. 1) for example a video camera, and later went through up-scaling. The quality of image N (330) after the step of upscaling is insufficient and requires super resolution. The method described below provides a new and unobvious method for determining pixel values, the method providing high-resolution image out of up-scaled low-resolution image N (330). In the example described, pixel 335 of image N (330) having indices (i, j) is the handled pixel and image N (330) is the handled image. Processing unit (130 of FIG. 1) determines the value of handled pixel 335 by comparing area 340 surrounding handled pixel 335 to areas located in neighboring images within a predetermined range. For simplicity of the explanation, and without imposing such limitations on the solution in general, the areas are 3*3 pixels in size, and the neighboring images are image N−1 (310) captured before handled image N (330) and image N+1 (350) captured after handled image N (330).

Basic area 340 of handled image N (330) is stored in memory unit (120 of FIG. 1) and compared to basic area 320 surrounding pixel 315 of image N−1 (310) and basic area 360 surrounding pixel 355 of image N+1 (350). Basic areas 320, 360 are located in substantially the same location in the neighboring images as the location of area 340 in handled image N (340). The locations of pixel 355 in image N+1 (350) and the location of pixel 315 in image N−1 (310) are substantially the same location of handled pixel 335 in handled image N (330). In an exemplary embodiment of the subject matter, area 340 of handled image N (330) contains pixels 331-339, and the center pixel within area 340, pixel 335, is handled.

In the exemplary embodiment, basic area 320 of image N−1 (310) contains pixels 311-319, contained within rows i−1 to i+1 and columns j−1 to j+1. Pixel 315 is located on row i and column j. When comparing area 340 containing handled pixel 335 to areas in neighboring images, areas located near the basic areas are also compared to area 340. For area 340. For example, area 321 is an offset area of image N−1 (310) located in rows i−2 to i and columns j−2 to j. Area 321 contains pixels 306-312, 314 and 315. The pixel value of each pixel in area 321 is compared to a pixel value of a respective pixel in area 340. For example, the pixel value of pixel 335 located in the center of area 340 is compared to the pixel value of pixel 311 located in the center of area 321. According to some embodiments of the method disclosed in FIG. 3, area 340 may be compared with only a portion of the areas within the predetermined range, within the neighboring images. For example, the comparison may be performed with only a third of the areas, randomly chosen, according to the pixel value of the pixel located in center of the areas, according to the location of the central pixel within the area, and the like.

After comparing pixel values of each area within the range to area 340 that contains handled pixel 345, a weight value W_{(M,T)} is obtained, associated with the offset M and the specific neighboring image T. For example, when comparing pixel values of area 340 to pixel values of area 321, the weight value W_{(M,T)} is stored in memory unit 120 or storage 140 (both shown in FIG. 1) as W_{(1,1)}. This indicates that the offset of one row up and one column up is offset number 1, and image N−1 is stored as image 1 in memory unit (120 of FIG. 1). The weight value is a function of the differences between the pixel values of area 340 and the pixel values of the area compared to area 340. The pixel value of handled pixel 345 is then assigned to a function of summing the multiplications of the weight values and the pixel values of the detected areas of neighboring images such as basic area 320 and area 321. In other embodiments, only the pixel values of centers of the areas are detected and used for further process.

Another technical problem addressed in the subject matter is to provide a penalty function that avoids the determination of motion vectors and yet provides sufficient results. A penalty function is a method of developing a family of algorithms for improving the resolution of images. Such a penalty function receives known low-resolution images, and a candidate super-resolution outcome, and determines a penalty value as a function of these given items to indicate the quality of the super-resolution outcome match to the given low-resolution images. Determining efficient and accurate penalty functions leads to determining the high-resolution image from a low-resolution image.

One known penalty function for super-resolution is given by

$$ɛ ( X ) = \frac{1}{2} {{\sum }^{T}}_{[ x ]} {‖ {DHF}_{l} X - {y}_{t} ‖}_{2}^{2}$$

Wherein parameter D refers to the resolution-scale factor, for example the numbers of rows, columns, or pixels that were previously removed when the image was downscaled. In other embodiments, D depends on the ratio between the number of pixels in the high resolution image to the number of pixels in the low resolution image. Alternatively, D refers to the ratio between the amount of data related to the high-resolution image and the amount of data related to the low resolution image. Parameter H refers to the blurriness of the image, sometimes caused by the camera's point spread function (PSF) that have various solutions known in the art. The parameter Fₜ refers to the warping of the image between the correct location of a pixel and the actual location of the pixel in the up-scaled image, in each neighboring image t for each pixel.

In order to find the super-resolution image that best fits the images yₜ, the penalty function is derived to determine its minimal value. Finding the minimal value of a penalty function is equivalent to determining the best method for transforming low-resolution images into the desired image X, according to the penalty term.

Finding the operators Fₜ is a problematic issue when determining the penalty function according to the algorithm disclosed in the prior art, since it requires determining and storing motion vectors for each pixel. The disclosed algorithm avoids determining the correction vector between the actual location of pixels in the low-resolution image provided to the computational entity that improves the resolution of the image and the correct location that should be in the desired high-resolution image. The parameter yₜ refers to the known low-resolution image and the parameter X refers to the desired high-resolution image. Indexing parameter t indicates summing over the number of T neighboring images compared to the handled image.

The new and unobvious disclosed penalty function results from data acquired from the low-resolution images while avoiding the use of external data such as motion vectors, predictions, and the like. Additionally, the method disclosed in the subject matter uses only basic rather than complex computations. The new method also saves memory since motion vectors and the difference in pixel locations respective to other images are not stored. The result of the method of the subject matter is a penalty function shown below:

$$ɛ ( X ) = \frac{1}{2} {\sum }_{m = 1}^{M} {\sum }_{t = 1}^{T} {‖ {DHF}_{m} X - {y}_{t} ‖}_{{W}_{m , t}}^{2}$$

The new and unobvious penalty function uses fuzzy motion estimation Parameters D and H are the same as in the penalty function provided in prior art methods. One major difference compared to prior art penalty functions is the lack of traditional F parameter, used for finding the difference between the location of a pixel in the correct image and the location of the same pixel in the provided image. Parameter Fₘ denotes the set of possible simple translations that image X may undergo in order to transform the entire image X into a new location. Additionally, the parameter Fm may contain a set of transformations that contain various types of motions, such as rotations, zooms, and the like. For example, one translation is an offset of one column up performed on an area compared with an area surrounding the handled pixel (such as pixel 245 of FIG. 2) within the handled image. After comparisons of pixel values of the area surrounding the handled pixel to basic areas (such as basic area 320 of FIG. 3) and offset areas (such as area 321 of FIG. 3) of neighboring images are performed, each comparison is assigned a weight value that refers to the level of importance of the specific compared area. The summation over M offsets and the weight values (shown as W_{m,t}, which is a matrix containing a weight for each pixel, probably different from one another) provided for each offset replace the need for determining motion vectors represented by Fₜ in prior art methods and provides more accurate results in less complexity. This results with fuzzy motion estimation that may assign for a pixel several origins in its neighborhood.

Another major difference using fuzzy motion estimation for improving the resolution of an image is that the summation according to the subject matter is double, instead of single summation as suggested in the previous method. In other words, all the number of neighboring images (T) and offsets (M) are taken into consideration, instead of the prior art methods that refer to a single, constant offset for the entire image (M). The additional summation refers to the offsets (M) of the location of the areas compared to the area surrounding the handled pixel, relative to the location of the base areas. In case the area's offset is two rows up and down, and two columns to each side, the number of offset areas (M) for each neighboring image is 25 (5 in each dimension, including the same pixel and two pixels in each direction). The weight value (W_{m,t}) is a comparison comparison function performed between pixel values or other image-related parameters of the handled area (such as area 250 of FIG. 2) and pixel values of areas within the neighboring image, in each offset, computed for each pixel.

Another approach to design a penalty function for the development of super-resolution techniques is based on the non-local means (NLM) method described below. As the NLM is originally designed for noise removal, it is first described for this task, and then extended to super-resolution.

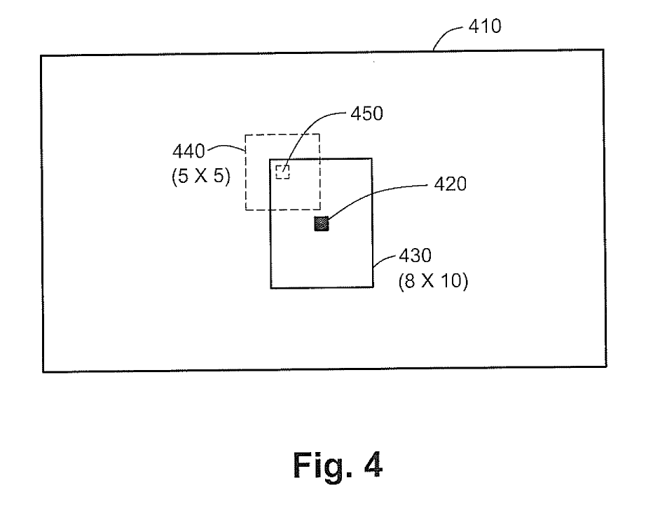

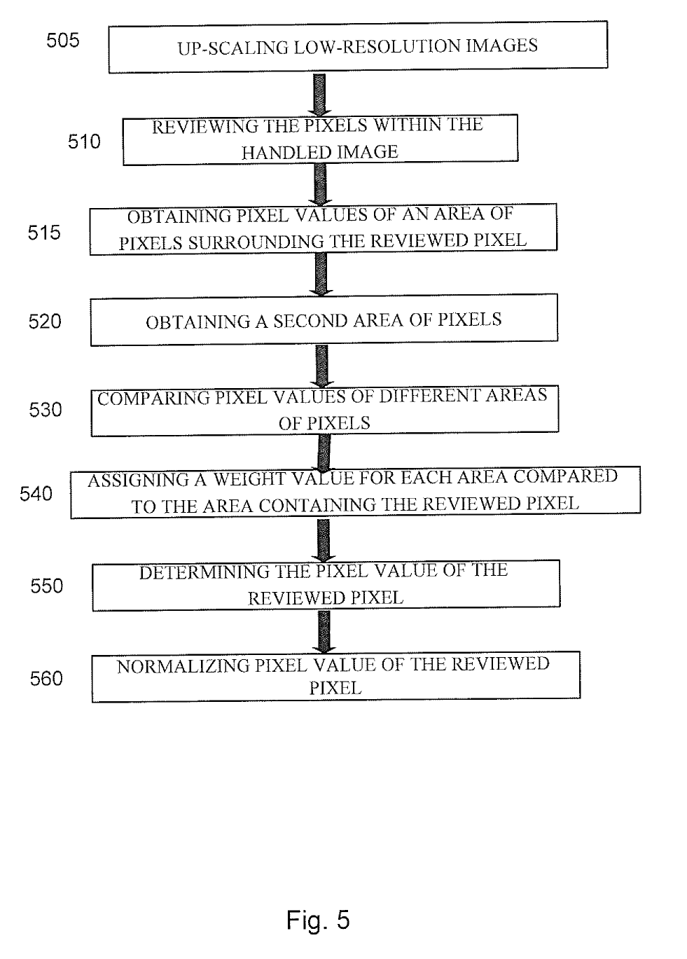

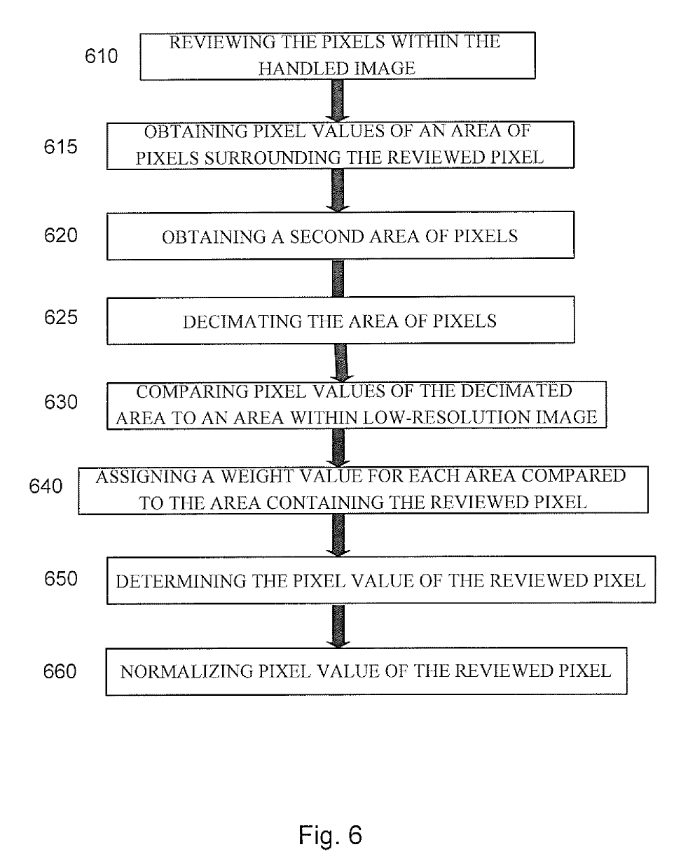

FIG. 4 illustrates a low-resolution image yₜ (410) on which a method for improving the resolution of an image is implemented by generalizing non-local means (NLM) algorithm, according to an exemplary embodiment of the subject matter. The starting point of the method is a denoising filter performed by averaging pixel values of pixels located in the vicinity of the pixel to be denoised. The denoising filter may be a bilateral filter used as a weight value multiplied by a function of pixel values of an area of pixels surrounding a handled pixel.

$${w}_{bilateral} [ k , l , i , j ] = {e}^{\frac{- {( y [ k , l ] - y [ i , j ] )}^{2}}{2 {σ}_{r}^{2}}} \cdot f ( \sqrt{{( k - i )}^{2} + {( l - j )}^{2}} )$$

The parameter y[k,l] refers to an area surrounding a pixel located on row k and column l and the power of e indicates the difference between the pixel value of a pixel having indices [k,l] and the pixel value of a pixel having indices [i,j]. The exponentiation e is multiplied by a function f that takes into account the distance between the location of index [i,j] and index [k,l] in the low-resolution image y (410).

In another embodiment, the weight value is a function of an NLM filter shown below. The main difference between the NLM filter and the bilateral filter is the use of areas (R_{k,l}) surrounding the pixel in index [k,l] when comparing images.

$${w}_{NLM} [ k , l , i , j ] = {e}^{\frac{- {‖ {R}_{k , l} y - {R}_{i , j} y ‖}^{2}}{2 {σ}_{r}^{2}}} \cdot f ( \sqrt{{( k - i )}^{2} + {( l - j )}^{2}} )$$

An unobvious penalty function is defined below for transforming the low-resolution images yₜ into a desired super-resolution image X. The penalty function uses weight values resulting from NLM or bilateral filters disclosed above, or weights relying on other image-related parameters. The weights determined for the penalty functions, as well as weights determined in the methods disclosed hereinafter in the subject matter, may be any function of image-related parameters and are not limited to pixel values. Further, the determination of weight values is not limited to the methods disclosed in the subject matter, but to any method or function provided by a person skilled in the art. The parameter R_{k,l} refers to the area surrounding the pixel in row k and column l, i.e., the pixel in index [k,l]. Parameter t indicates that the comparison between areas is performed for t neighboring images. Index [k,l] is detected in the entire image, while index [I,j] is detected only in the neighborhood of index [k,l]. The penalty function is:

$$ɛ ( X ) = \frac{λ}{2} {‖ x - y ‖}_{2}^{2} + \frac{1}{4} {\sum }_{k , l ∈ Ω} {\sum }_{i , j ∈ N ( k , l )} {w}_{k , l , i , j} \cdot {‖ {R}_{k , l} x - {R}_{i , j} x ‖}_{2}^{2}$$

An iterative approach is used to minimize this penalty, where pixel value of each pixel in the low-resolution image y is updated on each iteration until the updated y is sufficiently similar to the desired image x, or has a level of resolution that is higher than a predetermined resolution value. According to one exemplary embodiment of the subject matter, the method for iterative approach uses the formula below. xⁿ is a desired image, resulting from n iterations starting from x⁰.

$${x}^{n} = {[ λ + {\sum }_{k , l ∈ Ω} ( {\sum }_{i , j ∈ N ( k , l )} {w}_{k , l , i , j} ) {R}_{kl}^{T} {R}_{kl} ]}^{- 1} [ λ y + {\sum }_{k , l ∈ Ω} {R}_{kl}^{T} {\sum }_{i , j ∈ N ( k , l )} {w}_{k , l , i , j} {R}_{ij} {x}^{n - 1} ]$$

Using the iterative approach, the input to the penalty function is a low-resolution image x⁰. Next, an image sized as x⁰ is initialized, with all pixel values set to zero. The method reviews all pixels in the initialized image. In the example below, the reviewed pixel is pixel 420. For each reviewed pixel 420, an area 430 surrounding reviewed pixel 420 is used. Area 430 comprises multiple pixels, such as pixel 450, in the neighborhood of reviewed pixel 420. For each pixel located in area 430 in the neighborhood of reviewed pixel 420, an area 440 surrounding each pixel located in area 430 is retrieved. Preferably, area 440 is smaller than or equal to area 430. The pixel values of area 440 surrounding each pixel located in area 430 are multiplied by a weight value. The weight value is specific to the relations between reviewed pixel 420 and pixel 450 in the area 430 surrounding the reviewed pixel 420. Other methods for determining a weight value are provided in association with FIG. 2 and FIG. 3 above.

In other embodiments, area 440 or area 430 is up-scaled, so both areas 430, 440 have the same size. Then, pixel values of area 430 are compared with pixel values of area 440, and the weight value is a function of the difference between the pixel values. After multiplying the pixel values of pixels located in area 440 by the weight value, the result is added to the pixel values of the initialized image, in the pixels surrounding the location of reviewed pixel 420. After the pixel values of pixels surrounding the location of reviewed pixel 420 are extracted, a step of normalizing is provided. In an exemplary embodiment of the subject matter, area 430 surrounding reviewed pixel 420 is larger than area 440 surrounding each pixel such as pixel 450 that surround reviewed pixel 420. In an alternative embodiment of the disclosed subject matter, determining the weight values can be done using areas in the low-resolution images before the upscaling step instead of comparing interpolated images.

Another aspect of the disclosed subject matter relates to providing super resolution without explicit motion estimation. The first step is obtaining and minimizing a penalty function. The input to the penalty function is a set of low-resolution images. The method for improving the resolution of the images in the sequence of images is performed for each image separately. The size of the area taken from the high-resolution image is to be adjusted to fit the size of the areas of pixels taken from the low-resolution images. The adjustment is performed since the desired image X and the input images y have different sizes and different number of pixels, in order to accurately compare the pixel values of equivalent regions in the two types of images. The penalty function suggested is shown below.

$$ɛ ( X ) = \frac{1}{4} {\sum }_{k , l ∈ Ω} {\sum }_{t = 1}^{T} {\sum }_{i , j ∈ N ( k , l )} {w}_{k , l , i , j , t} \cdot {‖ {D}_{p} {R}_{k , l}^{H} HX - {R}_{i , j}^{L} {y}_{t} ‖}_{2}^{2} + λ TV ( X )$$

The new and unobvious penalty term overcomes the technical problem of the operator Rₖₗ that can only detect a minor portion of the pixels in the area surrounding a handled pixel. Operator Rₖₗ cannot detect all pixels surrounding the handled pixel, since according to prior-art methods, the decimation step which results in down-scaling the image, is performed prior to detecting pixel values. According to an exemplary embodiment of the subject matter, the method first detects pixel values and then decimates the area previously detected. The decimation is performed in order to enable comparing areas of pixels having substantially the same sizes in the penalty function. For example, when comparing the left quarter of a low-resolution image to the left quarter of a high-resolution image in a penalty function, the area detected from the high-resolution image should be decimated. When performing decimation after detecting the area of pixels, more data is detected and can be used to determine more accurate pixel values in the low-resolution image. Parameter Dₚ refers to the step of decimation performed on the area of pixels detected by operator Rₖₗ from the high-resolution image X. As a result, the area detected by operator Rᵢⱼ detected from the low-resolution image yₜ can successfully be compared to an equivalent area detected by operator Rₖₗ from the high-resolution image after the area detected by operator Rₖₗ is decimated. In an exemplary embodiment of the subject matter, the ratio between the size of area detected by operator Rₖₗ and the size of area detected by operator Rᵢⱼ is constant and is called a decimation factor, used for decimating areas detected by operator Rₖₗ. The functional TV refers to a total variation value added for smoothing the low-resolution image, and it may replaced by many regularizing functionals known to a person skilled in the art.

FIG. 5 shows a flowchart of several methods for improving the resolution of images, according to some exemplary embodiments of the disclosed subject matter. The method is preferably performed on images captured from a sequence of images, for example captured using a video camera. On step 505, at least a portion of the image within the sequence of images are up-scaled. The size to which the images are up-scaled may be predetermined and may vary according to parameters related to the images, or to the computerized entity performing the method. The up-scaled images may have equal or different sizes. On step 510, pixels within the handled image are reviewed by the computerized entity. Next, on step 515, pixel values of pixels surrounding the handled pixel are obtained. The size of the area may vary. In some exemplary embodiments of the disclosed subject matter, the handled pixel is located in the center of the area. In other embodiments, the handled pixel is not in the center of the area. Next, on step 520, areas from temporal-neighboring images are detected by the computerized entity. Such temporal-neighboring images may be mages that were captured up to a predetermined period of time before or after the handled image. The number of temporal-neighboring images may be predefined or vary according to the size of the images, pixel values of the handled image, standard deviation of the pixel values of pixels within the area, and the like. On step 530, the pixel values of pixels within the area containing the handled pixel are compared with pixel valued of the areas obtained on step 520. The result of the comparison is preferably numeric, more preferably a function of a mean square error (MSE). On step 540, a weight value is assigned to the area that was compared to the area containing the handled pixel on step 530. The weight value is preferably a function of the numeric value resulting from the comparison of step 530. According to some exemplary embodiments, the weight value is an exponentiation having a power that is a function of the MSE value. On step 550, the computerized entity determines the new value of the handled pixel. In some exemplary embodiments, a new image is generated and inputted with the new pixel values of the handled image. Alternatively, the pixels values of the handled image are updated. The new value of the handled pixel is a function of multiplying weight values of different areas with at least a portion of the pixels in the respective areas. In some exemplary embodiments of the disclosed subject, matter, only pixel values of pixels that were part of the low-resolution images, before the step of up-scale, are taken into consideration and multiplied by the weight value. On step 560, the new pixel values are normalized by dividing the result of the multiplications on step 550 by the sum of all relevant weight values.

FIG. 6 shows a flowchart of several methods for improving the resolution of images while avoiding a step of up-scaling images, according to some exemplary embodiments of the disclosed subject matter. The method disclosed in FIG. 6 is generally similar to the method disclosed in FIG. 5. On step 610, pixels in the handled image are reviewed, and areas of pixels surrounding the reviewed pixels are obtained or step 615. The area of step 615 is obtained from an up-scaled image, while the area of pixels detected on step 620 is detected from a low-resolution image. Hence, for covering the same ratio in the images, the size of both area of step 615 and the areas of step 615 is require to be modified. Therefore, on step 630, the size of one of the areas is changed. In an exemplary embodiment of the disclosed subject matter, the larger area is decimated to reduce the resource consumption of the computerized entity performing the method. After modifying the size of at least one of the areas, they are compared on step 640, and a weight value is assigned to the area compared to the area containing the handled pixel The determination of the pixel value on step 650 and normalizing as disclosed on step 660 are substantially equivalent to steps 550, 560, respectively.

One technical effect of the methods described above is the ability to use several processors, each processor analyzing another part of the handled image and thus reduce the time required for improving the resolution. Another technical effect is the lack of requirement to determine, store and use motion vectors when improving the resolution of a sequence of images. Another technical effect is the use of an iterative approach that can be terminated when the level of resolution is higher than a predefined level. Another technical effect is the use of small areas in large numbers, for achieving better images.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method of re-sampling a handled image within a sequence of images, the method comprising:
reviewing image-related data of the handled image;
obtaining image-related data of a first area located in the vicinity of a handled image-related object;
obtaining image-related data of additional areas located within other images in the sequence of images; said additional areas contain image-related data located in the vicinity of the location of the handled image-related object in the handled image;
comparing image-related data of the first area with image-related data of the additional areas; and,
assigning a weight value to at least one area of the additional areas, said weight value is a function of the image-related data of the first area and image-related data of the at least one area of the additional areas.

2. The method according to claim 1, further comprising a step of determining the value of the handled image-related object as a function of the image-related data of the additional areas and the weight value assigned to the additional areas.

3. The method according to claim 1, further comprising a step of normalizing the value of the handled image-related object as a function of the sum of weight values assigned to at least a portion of the additional areas.

4. The method according to claim 1, wherein the difference between image-related data within the first area and image-related data within the additional areas is determined as a function of an MSE value.

5. The method according to claim 1, wherein the weight value is assigned as a function of time elapsed between capturing the image containing the handled image-related object and the image containing the additional area compared to the first area.

6. The method according to claim 1, wherein the weight value is assigned as a function of the number of images captured between capturing the image containing the handled image-related object and an image containing an area compared to the first area.

7. The method according to claim 1, wherein the distance between the handled image-related object and the center of each additional area is limited to a predetermined number of rows or columns.

8. The method according to claim 1, further comprising a step of upscaling the images within the sequence of images.

9. The method according to claim 8, wherein comparing is performed only on image-related data of the images before upscale.

10. The method according to claim 1, further comprising a step of smoothing the handled image.

11. The method according to claim 1, wherein the image-related data is selected from a group consisting of a pixel, gradient, frequency domain value, transform domain coefficient or any combination thereof.

12. The method according to claim 1, wherein adapted to the purposes of improving its resolution, de-interlacing, or inpainting,

13. A method for re-sampling a handled image, comprising:
reviewing image-related data within the handled image;
obtaining image-related data of a first area located in the vicinity of at least one handled image-related object:
obtaining at least one secondary area associated with at least a portion of the at least one handled image-related object of the first area and located in the vicinity of the at least one handled image-related object of the first area;
assigning a weight value for the at least one secondary areas;
determining an accumulation value associated with a specific handled image-related object in a secondary area as a function of the image-related data associated with the specific handled image-related object and the weight value;
wherein the offset between the location of the associated image-related object and the location of the handled image-related object is a function of the offset between the location of the image-related object in the plurality of secondary areas and the location of the object in the first area.

14. The method according to claim 13, further comprising a step of initializing a second image having the same size as the handled image, said second image having initialized pixel values of zero;

15. The method according to claim 14, further comprising a step of adding said accumulation value to the value of the associated image-related object in the initialized image;

16. The method according to claim 14, wherein the steps are performed in an iterative manner, until the resolution of the initialized image is higher than a predetermined value.

17. The method according to claim 13, further comprising a step of normalizing the values of the image-related data within the initialized image.

18. The method according to claim 13, further comprising a step of changing the size of the first area or at least one secondary area, such that the size of the first area and the plurality of secondary areas is equal.

19. The method according to claim 13, wherein the weight value is determined as a function of the distance between the first area and the at least one secondary area.

20. The method according to claim 13, wherein the weight value is determined as a function of the difference between object values in the first area and object values of pixels in the plurality of secondary areas.

21. The method according to claim 13, wherein the object is selected from a group consisting of a pixel, gradient, frequency domain value, transform domain coefficient or any combination thereof.

22. A method for improving the resolution of an image, comprising:
obtaining a penalty function that avoids explicit and bijective warp operators;
inputting the image into the penalty function and resulting an improved image;
repeatedly inputting the improved image into the penalty function until the resolution of the improved image is higher than a predetermined value.

23. The method according to claim 22, wherein the inputted image is an up-scaled image compared to a plurality of low-resolution images.

24. The method according to claim 23, wherein an area within the inputted image is decimated before compared to an area within the plurality of low-resolution images.

25. A method for improving re-sampling low resolution images, the method comprising:
up-scaling the low-resolution image;
reviewing image-related objects within the up-scaled image;
obtaining values of image-related objects within an area located in the vicinity of the reviewed image-related objects;
decimating the area;
comparing the obtained values of image-related objects within the decimated area to values of other areas located in the images within the sequence of low resolution images; said other areas having substantially the same size as the decimated area.

26. The method according to claim 25, further comprising a step of assigning a weight value for the other areas and determining the image-related value of the reviewed image-related objects as a function of said weight value and said image-related values.

27. A method of re-sampling a handled image within a sequence of images, comprising:
obtaining a function of a desired image compared to at least one image of the sequence of images;
wherein the function determines the difference between the at least one image of the sequence of images and the desired image applied with a set of predefined transformations;
wherein the desired image undergoes blurring and decimation operations before determining the difference between said desired image and the at least one image of the sequence of images;
assigning a weight to at least one difference between the desired image applied with a set of predefined transformations and the at least images.

28. The method according to claim 27, wherein the at least one transformation is selected from a group consisting of zoom, rotation, offset or any combination thereof.

29. The method according to claim 27, further comprising a step of minimizing the function.
